(19) United States
(12) Patent Application Publication
(10) Pub. No.: US 2019/0124580 A1
(43) Pub. Date: Apr. 25, 2019

(54) METHOD AND DEVICE FOR BEARER ESTABLISHMENT

(71) Applicant: Telefonaktiebolaget LM Ericsson (publ), Stockholm (SE)

(72) Inventors: Qianxi Lu, Beijing (CN); Peng Chen, Nanjing (CN); Rui Fan, Beijing (CN); Peng Lv, Nanjing (CN); Hai Wang, Beijing (CN)

(21) Appl. No.: 16/089,231

(22) PCT Filed: Apr. 11, 2016
(86) PCT No.: PCT/CN2016/078973

§ 371 Date: Sep. 27, 2018

(51) Int. Cl. H04W 40/20; H04W 28/12; H04W 28/02

(52) U.S. Cl. CPC H04W 40/20; H04W 28/0226; H04W 28/12

(57) ABSTRACT

Embodiments of the disclosure generally relate to bearer establishment in a wireless communication network. In response to that a data packet is to be transmitted from a first terminal device served by a first base station to a second terminal device in a shortcut way, the first base station determines a second base station serving the second terminal device and a target bearer for carrying the data packet from the second base station to the second terminal device. Then, the first base station causes the data packet to be transmitted from the second base station to the second terminal device on the target bearer. In this way, latencies of bearers related to core network transportation can be reduced.

### TECHNICAL FIELD

Embodiments of the present disclosure generally relate to the field of communications, and more particularly, to a method and device for bearer establishment.

### BACKGROUND

Wireless communication networks are advancing to provide good service quality, support a high data rate and keep up with the continuously increasing demand for wireless data traffic. For the 3rd Generation Partnership Project (3GPP) which builds the network in a centralized way, conventionally, bearers go to reach another internal or external counterpart via a centralized entity, for example, Public Data Network (PDN) Gateway (P-GW) in Evolved Packet Core (EPC). The bearers include, for example, but not limited to, a PDN connection consisting of a Data Radio Bearer (DRB) between a terminal device and a base station (BS), a S1 bearer between the BS and a Serving Gateway (S-GW), and a S5 bearer between the S-GW and the P-GW. In such a case, latency of the connection may include latency of the DRB, for example, latency in an air interface like Uu, latency of the S1 bearer, latency of the S5 bearer, and the like.

The conventional bearer establishment mechanism is undesirable for data traffic. By way of example, for the communication between two terminal devices in the same cell or in neighboring cells, the latencies caused by the bearer establishment mechanism would cause undesirable delay of the data traffic. In particular, for mission critical traffic, which has quite a strict time requirement, such latencies may have a negative effect and need to be reduced.

### SUMMARY

In general, embodiments of the present disclosure provide a solution for bearer establishment in a wireless communication network.

In a first aspect, a method implemented by a BS in a wireless communication network is provided. In response to that a data packet is to be transmitted from a first terminal device served by a first base station to a second terminal device in a shortcut way, the first base station determines a second base station serving the second terminal device and a target bearer for carrying the data packet from the second base station to the second terminal device. Then, the first base station causes the data packet to be transmitted from the second base station to the second terminal device on the target bearer. The corresponding computer program is also provided.

In one embodiment, the method may further include: in response to receiving, from a mobility management entity, shortcut information indicating the second base station and the target bearer, determining that the data packet is to be transmitted to the second terminal device in a shortcut way.

In one embodiment, the method may further include: transmitting the data packet to a network node, to enable the network node to identify the first terminal device and the second terminal device from the data packet, determine whether the second terminal device is in proximity to the first terminal device, and transmit proximity information to the mobility management entity if the second terminal device is in proximity to the first terminal device to trigger the mobility management entity to determine the shortcut information based on the proximity information.

In one embodiment, the method may further include: identifying the first terminal device and the second terminal device from the data packet; and transmitting information about the first terminal device and the second terminal device to the mobility management entity, to enable the mobility management entity to determine whether the second terminal device is in proximity to the first terminal device and determine the shortcut information if the second terminal device is in proximity to the first terminal device.

In one embodiment, determining the second base station and the target bearer may further include: determining the second base station and the target bearer from the shortcut information.

In one embodiment, the method may further include: identifying the first terminal device and the second terminal device from the data packet; determining whether the second terminal device is in proximity to the first terminal device; and in response to determining that the second terminal device is in proximity to the first terminal device, determining that the data packet is to be transmitted to the second terminal device in a shortcut way.

In one embodiment, determining whether the second terminal device is in proximity to the first terminal device may further include: collecting serving information about terminal devices served by neighboring base stations of the first base station; determining whether the second terminal device is served by one of the neighboring base stations based on the serving information; and in response to determining that the second terminal device is served by one of the neighboring base stations, determining that the second terminal device is in proximity to the first terminal device.

In one embodiment, determining the second base station and the target bearer may further include: determining the one of the neighboring base stations as the second base station; and selecting the target bearer from bearers available to the second base station.

In one embodiment, the first base station is different from the second base station. In the embodiment, causing the data packet to be transmitted from the second base station to the second terminal device on the target bearer may further include: transmitting the data packet to the second base station, to enable the second base station to transmit the data packet to the second terminal device on the target bearer.

In a second aspect, a method implemented at a network node in a wireless communication network is provided. The network node receives a data packet from a first base station, a source of the data packet being a first terminal device served by the first base station, and a destination of the data packet being a second terminal device. Then, the network node identifies the first terminal device and the second terminal device from the data packet. The network node determines whether the second terminal device is in proximity to the first terminal device. In response to the second terminal device being in proximity to the first terminal device, the network node transmits, to a mobility management entity, proximity information indicating that the second terminal device is in proximity to the first terminal device.

In one embodiment, the mobility management entity determines shortcut information based on the proximity information, the shortcut information indicating a second base station serving the second terminal device and a target bearer for carrying the data packet from the second base station to the second terminal device.

In a third aspect, a method implemented at a mobility management entity in a wireless communication network is provided. The mobility management entity determines whether a second terminal device is in proximity to a first base station, the first base station serving a first terminal device, and the first terminal device transmitting a data packet to the second terminal device. In response to determining that the second terminal device is in proximity to a first base station, the mobility management entity determines shortcut information indicating a second base station serving the second terminal device and a target bearer for carrying the data packet from the second base station to the second terminal device. Then, the mobility management entity transmits the shortcut information to the first base station, to cause the data packet to be transmitted from the second base station to the second terminal device on the target bearer.

In one embodiment, determining whether the second terminal device is in proximity to the first terminal device may further include: in response to receiving proximity information from a network node, determining that the second terminal device is in proximity to the first terminal device, the proximity information being determined at the network node in response to the second terminal device being in proximity to the first terminal device.

In one embodiment, determining whether the second terminal device is in proximity to the first terminal device may further include: receiving information about the first terminal device and the second terminal device from the first base station; and determining the second base station based on the received information; and if the second base station is a neighbor base station of the first base station, determining that the second terminal device is in proximity to the first terminal device.

In a fourth aspect, a BS in a wireless communication network is provided. The BS includes a controller and a transceiver. The controller is configured to a controller configured to in response to that a data packet is to be transmitted from a first terminal device served by the first base station to the second terminal device in a shortcut way, determine a second base station serving the second terminal device and a target bearer for carrying the data packet from the second base station to the second terminal device. The transmitter is configured to cause the data packet to be transmitted from the second base station to the second terminal device on the target bearer.

In a fifth aspect, a network node in a wireless communication network is provided. The network node includes a receiver, a controller and a transmitter. The receiver may be configured to receive a data packet from a first base station, a source of the data packet being a first terminal device served by the first base station, and a destination of the data packet being a second terminal device. The controller may be configured to: identify the first terminal device and the second terminal device from the data packet, and determine whether the second terminal device is in proximity to the first terminal device. The transmitter may be configured to, in response to the second terminal device being in proximity to the first terminal device, transmit, to a mobility management entity, proximity information indicating that the second terminal device is in proximity to the first terminal device.

In a sixth aspect, a mobility management entity in a wireless communication network is provided. The mobility management entity includes a controller and a transmitter. The controller is configured to: determine whether a second terminal device is in proximity to a first base station, the first base station serving a first terminal device, and the first terminal device transmitting a data packet to the second terminal device, and in response to determining that the second terminal device is in proximity to a first base station, determine shortcut information indicating a second base station serving the second terminal device and a target bearer for carrying the data packet from the second base station to the second terminal device. The transmitter is configured to transmit the shortcut information to the first base station, to cause the data packet to be transmitted from the second base station to the second terminal device on the target bearer.

In a seventh aspect, a device in a wireless communication network is provided. The device includes: a processor and a memory, the memory containing instructions executable by the processor, whereby the processor being adapted to cause the device to: in response to that a data packet is to be transmitted from a first terminal device served by the first base station to the second terminal device in a shortcut way, determine a second base station serving the second terminal device and a target bearer for carrying the data packet from the second base station to the second terminal device; and cause the data packet to be transmitted from the second base station to the second terminal device on the target bearer.

In an eighth aspect, a device in a wireless communication network is provided. The device includes: a processor and a memory, the memory containing instructions executable by the processor, whereby the processor being adapted to cause the device to: receive a data packet from a first base station, a source of the data packet being a first terminal device served by the first base station, and a destination of the data packet being a second terminal device; identify the first terminal device and the second terminal device from the data packet; determine whether the second terminal device is in proximity to the first terminal device; and in response to the second terminal device being in proximity to the first terminal device, transmit, to a mobility management entity, proximity information indicating that the second terminal device is in proximity to the first terminal device.

In a ninth aspect, a device in a wireless communication network is provided. The device includes: a processor and a memory, the memory containing instructions executable by the processor, whereby the processor being adapted to cause the device to: determine whether a second terminal device is in proximity to a first base station, the first base station serving a first terminal device, and the first terminal device transmitting a data packet to the second terminal device; in response to determining that the second terminal device is in proximity to a first base station, determine shortcut information indicating a second base station serving the second terminal device and a target bearer for carrying the data packet from the second base station to the second terminal device; and transmit the shortcut information to the first base station, to cause the data packet to be transmitted from the second base station to the second terminal device on the target bearer.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an environment of a wireless communication network 100 in which embodiments of the present disclosure may be implemented;

FIG. 2 shows a flowchart of a method 200 for bearer establishment implemented by a BS in accordance with an embodiment of the present disclosure;

FIG. 3 shows a flowchart of a method 300 for bearer establishment implemented by a BS in accordance with an embodiment of the present disclosure;

FIG. 4 shows a flowchart of a method 400 for bearer establishment implemented by a BS in accordance with an embodiment of the present disclosure;

FIG. 5 shows a flowchart of a method 500 for bearer establishment implemented by a BS in accordance with an embodiment of the present disclosure;

FIG. 6 shows a flowchart of a method 600 for bearer establishment implemented by a network node in accordance with an embodiment of the present disclosure;

FIG. 7 shows a flowchart of a method 700 for bearer establishment implemented by a mobility management entity in accordance with an embodiment of the present disclosure;

FIG. 8 shows a diagram 800 of a flow of bearer establishment in accordance with an embodiment of the present disclosure;

FIG. 9 shows a diagram 900 of a flow of bearer establishment in accordance with an embodiment of the present disclosure;

FIG. 10 shows a diagram 1000 of a flow of bearer establishment in accordance with an embodiment of the present disclosure;

FIG. 11 shows a block diagram of a BS 1100 in accordance with an embodiment of the present disclosure;

FIG. 12 shows a block diagram of a network node 1200 in accordance with an embodiment of the present disclosure;

FIG. 13 shows a block diagram of a mobility management entity 1300 in accordance with an embodiment of the present disclosure; and

FIG. 14 shows a simplified block diagram 1400 of a BS, a network node or a mobility management entity that is suitable for use in implementing embodiments of the present disclosure.

### DETAILED DESCRIPTION

The present disclosure will now be discussed with reference to several example embodiments. It should be understood that these embodiments are discussed only for the purpose of enabling those skilled persons in the art to better understand and thus implement the present disclosure, rather than suggesting any limitations on the scope of the present disclosure.

As used herein, the term “base station” refers to an access point (AP) providing service to terminal devices in a wireless communication network. The BS may be, for example, a node B (NodeB or NB), an evolved NodeB (eNodeB or eNB), a Remote Radio Unit (RRU), a radio header (RH), a remote radio head (RRH), a relay, a low power node such as a femto, a pico, and so forth.

The term “terminal device” refers to user equipment (UE), which may be a Subscriber Station (SS), a Portable Subscriber Station, a Mobile Station (MS), or an Access Terminal (AT). The terminal device may include, but not limited to, a mobile phone, a cellular phone, a smart phone, a tablet, a wearable device, a personal digital assistant (PDA), and the like.

The term “network node” refers to a node between the BS and a core network. The network node may be, for example, a gateway such as the P-GW, a controller, a server, or any other suitable node in the wireless communication network.

As used herein, the terms “first” and “second” may refer to different elements or the same element. The singular forms “a” and “an” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

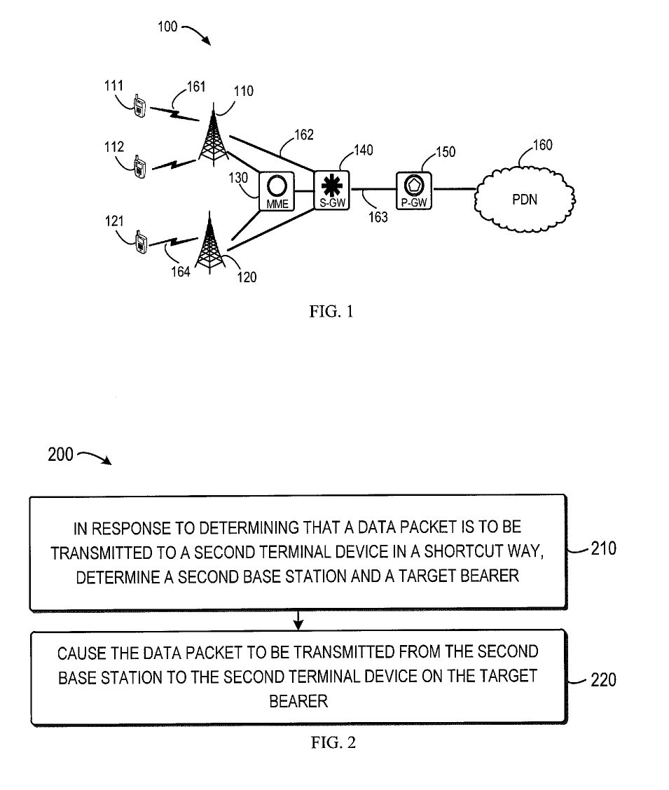

Now some exemplary embodiments of the present disclosure will be described below with reference to the figures. Reference is first made to FIG. 1, which illustrates an environment of a wireless communication network 100 in which embodiments of the present disclosure may be implemented. The wireless communication network 100 may follow any suitable communication standards, such as LTE-Advanced (LTE-A), LTE, Wideband Code Division Multiple Access (WCDMA), High-Speed Packet Access (HSPA), and so on. Furthermore, the communications between the terminal device 120 and the BS 110/130 in the network 100 may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future.

As shown in FIG. 1, the wireless communication network 100 includes a first BS 110 and connects, via a S-GW 140 and a P-GW 150, to a core network, which is implemented as a PDN 160. The wireless communication network 100 further includes a second BS 120, which is a neighbor of the BS 110 and also connects, via the S-GW 140 and the P-GW 150, to the PDN 160. Both the first BS 110 and the second BS 120 communicate with a mobility management entity (MME) 130. In the example of FIG. 1, there illustrate two terminal devices, UE 111 and UE 112, in the coverage of the first BS 110, and one terminal device, UE 113, in the coverage of the second BS 120. The latency of data traffic between the UE 111 and the PDN 160 may include latency of a DRB 161 between the UE 111 and the first BS 110, latency of a S1 bearer 162 between the first BS 110 and the S-GW 140, latency of a S5 bearer 163 between the S-GW 140 and the P-GW 150, and so on.

Conventionally, mission critical traffic which has a quite strict time requirement has been paid more attention and used widely. For example, Mission Critical Push-to-talk (MCPTT) emulates functions provided by professional mobile radio (PMR) systems and can be supported by both group call and private one-to-one calls. Another type of mission critical traffic is in the Machine Type Communications (MTC) field, for example, Vehicle to Vehicle (V2V), Car to Car (C2C), or the like. However, due to bearer latencies, such as the latencies of the DRB 161, the S1 bearer 162 and the S5 bearer 163, the wireless communication network 100 cannot meet the need for V2V with a critical time tolerance (a typical delay is about 30 ms-100 ms). In particular, in the case that a data packet is to be transmitted from the UE 111 to the UE 112, conventionally, the UE 111 transmits the data packet to the BS 110, and then the BS 110 transmits the data packet to the PDN 160 via the S-GW 140 and the P-GW 150. The PDN 160 determines the destination of the data packet, namely, the UE 121, and sends the data packet to the BS 120 via the P-GW 150 and the S-GW 140. Then, the BS 120 transmits the data packet to the UE 121. As such, the latency for the transmission of the data packet is relatively large, which is undesirable and unacceptable for the mission critical traffic.

In order to solve the above and other potential problems, embodiments of the present disclosure provides solutions for shortcut transmission to reduce latency in the wireless communication network 100. In accordance with embodiments of the present disclosure, the first BS 110 determines whether a data packet from the first terminal device (for example, the UE 111) is to be transmitted to a second terminal device (for example, the UE 121) in a shortcut way. If so, the first BS 110 determines a second base station serving the UE 121. In this example, the second base station is the BS 120. Further, the first BS 110 determines a target bearer (for example, the bearer 164) for carrying the data packet from the BS 120 to the UE 121. Then, the BS 110 causes the data packet to be transmitted from the BS 120 to the UE 121 on the target bearer. As such, the data packet can be transmitted from the UE 111 to the UE 121 in a shortcut way, instead of via the S-GW 140, the P-GW 150 and the PDN 160. In this way, a shortcut bearer is established for transmitting the data packet, and it is thus possible to reduce latencies, such as the latency of the S1 bearer and the latency of the S5 bearer, in the transmission of the data packet.

It is to be understood that the configuration of FIG. 1 is described merely for the purpose of illustration, without suggesting any limitation as to the scope of the present disclosure. Those skilled in the art will appreciate that the wireless communication network 100 may include any suitable number of terminal devices and BSs and may have other suitable configurations.

Now reference is made to FIG. 2, which shows a flowchart of a method 200 for bearer establishment implemented by a device in accordance with an embodiment of the present disclosure. With the method 200, the above and other potential deficiencies in the conventional approaches can be overcome. It would be appreciated by those skilled in the art that the method 200 may be implemented by a base station, such as the BS 110 or other suitable devices. For the purpose of illustration, the method 200 will be described below with reference to the BS 110 in the wireless communication system 100.

The method 200 is entered in block 210, where in response to that a data packet is to be transmitted from a first terminal device served by the first base station to the second terminal device in a shortcut way, a second base station and a target bearer are determined. In accordance with embodiments of the present disclosure, the second base station and the target bearer may be determined in several ways.

In accordance with embodiments of the present disclosure, the “shortcut way” refers to directly transmitting the data packet from a first terminal device (for example, the UE 111) to a second terminal device (for example, the UE 121) via their respective serving nodes (for example, the BS 110 and the BS 120), without the need of transmitting the data packet to and from the core network.

There may be a variety of ways for determining whether the data packet is to be transmitted in the shortcut way. In some embodiments, the determination may be made according to shortcut information received from a mobility management entity, for example, the MME 130. The shortcut information indicates a second base station (the BS 120 in this example) for transmitting the data packet to its destination and a target bearer for carrying the data packet from the second base station to the second terminal device. Upon receipt of the shortcut information, the BS 110 may determine that the data packet is to be transmitted in a shortcut way.

Alternatively, in some embodiments, the BS 110 may make the decision by itself. For example, the BS 110 may determine the first terminal device (that is, the source of the data packet, UE 111) and the second terminal device (that is, the destination of the data packet, UE 121) from the data packet. Then, the BS 110 may determine whether the UE 121 is in proximity to the UE 111. If so, the BS 110 may determine that the data packet is to be transmitted to the UE 121 in a shortcut way.

In accordance with embodiments of the present disclosure, in response to that the data packet is to be transmitted in a shortcut way, the second base station and the target bearer may be determined in several ways. In some embodiments, the BS 110 may transmit the data packet to a network node, for example, the P-GW 150, to enable the network node to identify the first terminal device (for example, the UE 111) and the second terminal device (for example, the UE 121) from the data packet, determine whether the UE 121 is in proximity to the UE 111, and transmit proximity information to the mobility management entity (for example, the MME 130) if the second terminal device is in proximity to the first terminal device. Upon receipt of the proximity information, the MME 130 may be triggered to determine the shortcut information based on the proximity information. For example, the MME 130 may determine the base station serving the UE 121, namely, the BS 120, and may select a suitable bearer from bearers available to the BS 120 as the target bearer. Then the MME 130 may transmit the shortcut information to the BS 110. Upon receipt of the shortcut information, the BS 110 determines the second base station and the target bearer from the shortcut information.

Alternatively, in some embodiments, the shortcut information may be determined by the MME 130, instead of the P-GW 150. For instance, the BS 110 may identify the UE 111 and the UE 121 from the data packet and transmit information about the UE 111 and the UE 121 to the MME 130, to enable the MME 130 to determine whether the UE 121 is in proximity to the UE 111. If so, the MME 130 may determine the shortcut information. Then the MME 130 may transmit the shortcut information to the BS 110. Upon receipt of the shortcut information, the BS 110 determines the second base station and the target bearer from the shortcut information.

In accordance with embodiments of the present disclosure, if the BS 110 determines whether the data packet is to be transmitted in the shortcut way by itself, the BS 110 may collect serving information about terminal devices served by neighboring base stations of the UE 111. Then, the BS 110 may determine whether the UE 121 is served by one of the neighboring base stations based on the serving information. If so, the BS 110 may determine that the second terminal device is in proximity to the first terminal device. In such embodiments, in block 210, the BS may determine the one of the neighboring base stations as the second base station and select the target bearer from bearers available to the second base station.

In block 220, the data packet is caused to be transmitted from the second base station to the second terminal device on the target bearer. According to embodiments of the present disclosure, the first base station may be the same as the second base station or different from the second base station. In some embodiments, the first base station is the same as the second base station and the second terminal device is also served by the first base station. In the example shown in FIG. 1, the first base station and the second base station both may be the BS 110, and the first terminal device and the second terminal device may be the UE 111 and the UE 112, respectively. In particular, after determining the data packet is to be transmitted from the UE 111 to the UE 112 in a shortcut way, the BS 110 transmits the data packet to the UE 112 on the target bearer directly, without the need of transmitting the data packet to and from the PDN 160 via the S1 bearer, the S5 bearer, and so on.

Alternatively, in some embodiments, the first base station is different from the second base station. In the example shown in FIG. 1, the first base station may be the BS 110, the second base station may be the BS 120, the first terminal device may be the UE 111, and the second terminal device may be the UE 121. After determining the data packet is to be transmitted from the UE 111 to the UE 121 in a shortcut way, the BS 110 may transmit the data packet to the BS 120, to enable the BS 120 to transmit the data packet to the UE 121 on the target bearer directly. In this way, there is no need to transmit the data packet from the BS 110 to the PDN 160 and then transmit from the PDN 160 to the BS 120 via the S1 bearer, the S5 bearer, and so on. As a result, the latencies associated with the S1 bearer, the S5 bearer and the like can be avoided.

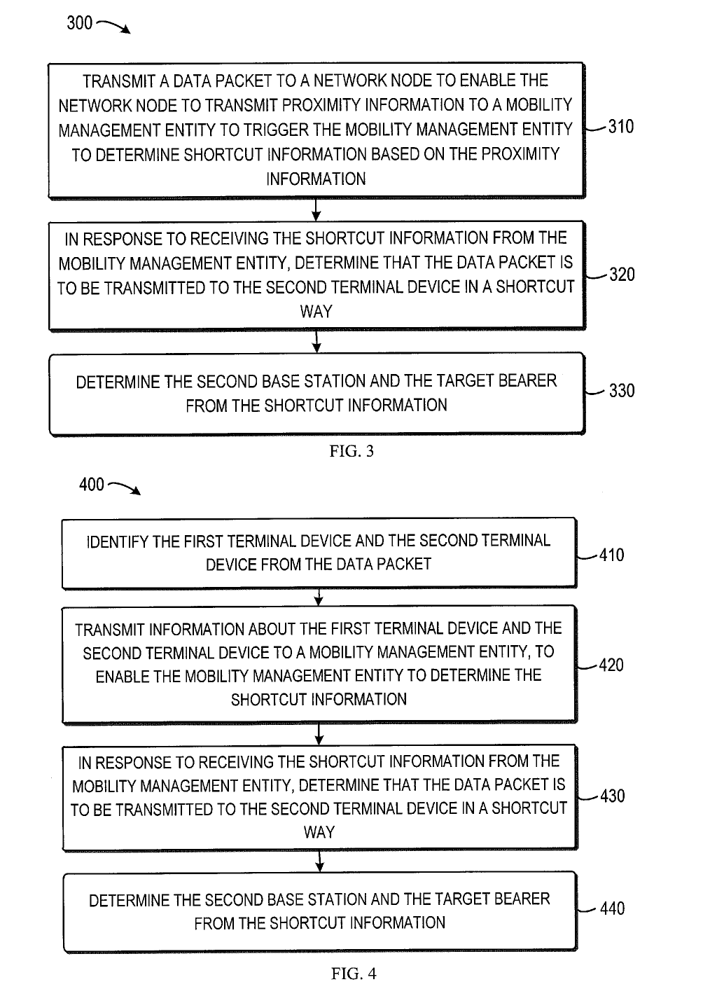

Now some example embodiments will be described with respect to FIG. 3. FIG. 3 shows a flowchart of a method 300 for bearer establishment implemented by a BS in accordance with an embodiment of the present disclosure. The method 300 may be considered as a specific implementation of block 210 of the method 200 described above with reference to FIG. 2. However, it is noted that this is only for the purpose of illustrating the principles of the present disclosure, rather than limiting the scope thereof.

The method 300 is entered in block 310, where a data packet is transmitted to a network node, for example the P-GW 150. As such, the P-GW 150 is enabled to identify the first terminal device and the second terminal device from the data packet. Then the P-GW 150 may determine whether the second terminal device is in proximity to the first terminal device. If so, the P-GW 150 may transmit proximity information to a mobility management entity, for example, the MME 130, trigger the mobility management entity to determine the shortcut information based on the proximity information.

In some embodiments, the procedure of determining whether the second terminal device is in proximity to the first terminal device may be implemented in several ways. In an embodiment, IP addresses of the source (that is, the first terminal device) and the destination (that is, the second terminal device) of the data packet may be inspected from the data packet, and then it may be determined whether the second terminal device is in proximity to the first terminal device by checking their IP addresses. For instance, the P-GW 150 may determine the IP address of the second terminal device is within the proximity of the first BS serving the first terminal device. This may be implemented by checking whether the second terminal device is served by the first base station or a neighbor of the first base station. If so, the P-GW 150 may determine that the second terminal device is in proximity to the first terminal device. Then, the P-GW 150 may provide proximity information indicating that the second terminal device is in proximity to the first terminal device to the MME 130.

In an embodiment, the proximity information may be transmitted to the MME 130 via a new/modified GPRS Tunneling Protocol-Control (GTP-C) signaling on S5 (from P-GW 150 to S-GW 140) and S11 (from S-GW 140 to MME 130) interface. The proximity information may include the identifier (ID) information of the first and second terminal devices. The ID information may be in a variety of forms, for example, International Mobile Subscriber Identification Number (IMSI), IP address, and Evolved Packet System (EPS) bearer ID.

In block 320, in response to receiving shortcut information from a mobility management entity, the data packet is determined to be transmitted to the second terminal device in a shortcut way. In some embodiments, the shortcut information may be transmitted from the MME 130 to the first BS 110. For instance, the shortcut information may be transmitted via a new/modified S1AP signaling on S1-MME interface (from the MME 130 to the first BS 110). In an embodiment, the shortcut information may be implemented as including a mapping table which maps from original uplink (UL) Tunnel Endpoint Identifier (TEID) at the S-GW 140, for example, {Original UL TEID, IP of the S-GW}, to a downlink (DL) TEID at the second BS 120, for example, {DL TEID of the second BS, IP of the second BS}. The DL TEID of the second BS indicates the target bearer for transmitting the data packet in the shortcut way.

It is to be understood that this is only for the purpose of illustrating the principles of the present disclosure, rather than limiting the scope thereof Those skilled in the art would appreciate that the shortcut information may be implemented in other suitable forms, as long as it indicates the second BS and the target bearer.

In an embodiment, the first terminal device and the second terminal device may be associated by the original bearer and the target bearer, wherein the original bearer is for transmitting the data packet between the first terminal device and the first BS. For instance, the first terminal device may use a TEID for UL transmission to the first BS, and the second terminal device may use a TEID which is different from the TEID 1 for DL transmission from the second BS. On the other hand, the first terminal device may use the TEID for DL transmission from the first BS, and the second terminal device may use the TEID for UL transmission to the second BS.

In block 330, the second base station and the target bearer are determined from the shortcut information. In some embodiments as discussed above, the second base station may be determined based on the IP address of the second terminal device, and the target bearer may be determined based on available bearers of the second base station. It is to be understood that this example is only for the purpose of illustrating the principles of the present disclosure, rather than limiting the scope thereof Those skilled in the art would appreciate that the second base station and the target bearer may be determined from the shortcut information implemented in other suitable forms.

According to embodiments of the present disclosure, optionally, if one bearer is used for multiple destinations, such as a host in Internet, a UE in proximity, and the like, then the core network requires a dedicated bearer for communication with the proximity UE, or the first BS checks the destination IP address of application layer from UE to know which data packet needs to be transmitted in a shortcut way. For example, if a destination IP address is for the host in Internet, then the data packet should be still delivered to the S-GW. If a destination IP address is for the proximity UE, then the data packet may be delivered to the second BS.

Further discussion of the embodiments of FIG. 3 may be found in FIG. 8, which shows a diagram 800 of a flow of bearer establishment in accordance with an embodiment of the present disclosure. The example of FIG. 8 illustrates the first BS 110, the second BS 120, the MME 130 and the P-GW 140 of FIG. 1, and the proximity determination is made at the P-GW side. When the flow shown in FIG. 8 starts, the first BS 110 transmits 811 a data packet to the P-GW 150. Upon receipt of the data packet, the P-GW 150 identifies 812 the first terminal device, for example, the UE 111, and the second terminal device, for example, the UE 121 from the data packet. In the example, it is assumed that the second BS is a neighbor of the first BS, and thus the P-GW 150 may determine 813 that the UE 121 is in proximity to the UE 111. Then, the P-GW 150 may transmits 814 proximity information indicating that the UE 121 is in proximity to the UE 111 to the MME 130. Then, the MME 130 determines the second BS 120 serving the UE 121 and a target bearer, and determines 815 shortcut information based thereon. Upon receiving 816 the shortcut information from the MME 130, the first BS 110 may determine 817 the second BS and the target bearer from the shortcut information and transmit 818 the data packet to the second BS 120 directly. In this way, the data packet can be transmitted from the second BS 120 to the second terminal device (the UE 121) via the target bearer. Thus the core network transportation can be bypassed and related latencies can be reduced.

Now further example embodiments will be described with respect to FIG. 4. FIG. 4 shows a flowchart of a method 400 for bearer establishment implemented by a BS in accordance with an embodiment of the present disclosure. The method 400 may be considered as a specific implementation of block 210 of the method 200 described above with reference to FIG. 2. However, it is noted that this is only for the purpose of illustrating the principles of the present disclosure, rather than limiting the scope thereof.

The method 400 is entered in block 410, where the first terminal device and the second terminal device are identified from the data packet. In the embodiments illustrated with respect to FIG. 4, the proximity determination is performed at the first base station and the P-GW is released from the procedure; meanwhile, the MME is still involved in the determination of the shortcut transmission. In block 410, the first BS 110 may identify the source and destination of the data packet as the first terminal device and the second terminal device.

In block 420, information about the first terminal device and the second terminal device is transmitted to the mobility management entity, to enable the mobility management entity to determine whether the second terminal device is in proximity to the first terminal device and determine the shortcut information if the second terminal device is in proximity to the first terminal device. In the embodiments, it is the first BS 110, rather than the P-GW 150 as discussion in embodiments of FIG. 3, that notifies the MME 130 about the IP address of the identified destination. The information about the terminal devices may be transmitted by using a new/modified S1AP signaling. In some embodiments, a bearer identifier, such as an EPS Bearer ID, a DRB ID and an E-RAB ID, may be included in the information as well.

Upon receipt of the information, the MME 130 may determine whether the destination IP address is within the proximity of source IP address, for example, by determining the second BS serving the second terminal device is the first BS or a neighbor of the first BS. In an embodiment, the MME 130 may make the determination based on IP addresses and ECGI info for each UE already available in the MME. If the MME 130 determines that the second terminal device is in proximity of the first terminal device, it may further determine a target bearer and shortcut information indicating the second BS and the target bearer. Then, the MME 130 may send the shortcut information to the first BS 110. In some embodiments, the shortcut information may be sent by using new/modified S1AP signaling on S1-MME interface (from MME to the first BS), where the key payload may include the TEID info, which is used by the first BS to connect a GPRS Tunnel Protocol (GTP) tunnel of the two terminal devices together. In an example, it may be implemented in a way that the first BS directly connects the TEID together.

In block 430, in response to receiving shortcut information from a mobility management entity, the BS 110 determines that the data packet is to be transmitted to the second terminal device in a shortcut way. In block 440, the BS 110 determines the second base station and the target bearer are from the shortcut information. Operations and features of blocks 430 and 440 are similar to those discussed with respect to the blocks 320 and 330, respectively. For the purpose of simplification, the details of blocks 430 and 440 will be omitted.

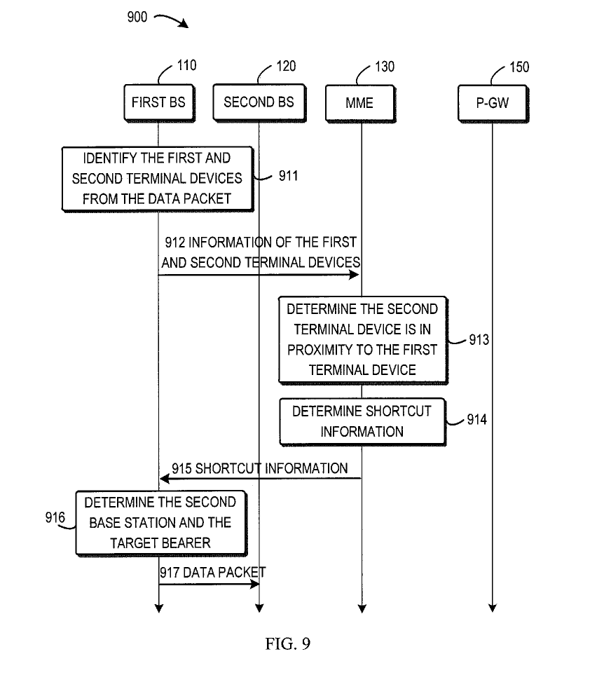

More details of the embodiments of FIG. 4 may be found in FIG. 9, which shows a diagram 900 of a flow of bearer establishment in accordance with an embodiment of the present disclosure. The example of FIG. 9 illustrates the first BS 110, the second BS 120, the MME 130 and the P-GW 140 of FIG. 1, and the proximity determination is made at the P-GW side. When the flow shown in FIG. 9 starts, the first BS 110 identifies 911 the first terminal device, for example, the UE 111, and the second terminal device, for example, the UE 121 from the data packet. Then, the first BS 110 may send 912 information about the first and second terminal devices (for example, the IP addresses of the UE 111 and the UE 121) to the MME 130. In the example, it is also assumed that the second BS is a neighbor of the first BS, and thus the MME 130 may determine 913 that the UE 121 is in proximity to the UE 111. Then, the MME 130 may determine the second BS 120 serving the UE 121 and a target bearer, and determines 914 shortcut information based thereon. Upon receiving 915 the shortcut information from the MME 130, the first BS 110 may determine 916 the second BS and the target bearer from the shortcut information and transmit 917 the data packet to the second BS 120 directly. In this way, the data packet can be transmitted from the second BS 120 to the second terminal device (the UE 121) via the target bearer. Thus the core network transportation can be bypassed and related latencies can be reduced.

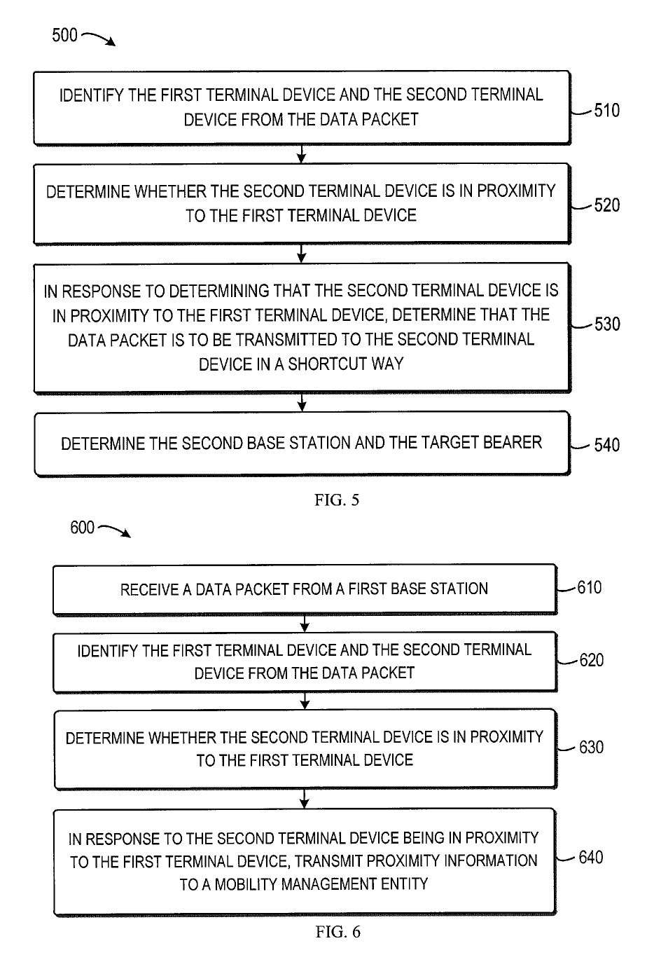

Now still further example embodiments will be described with respect to FIG. 5. FIG. 5 shows a flowchart of a method 500 for bearer establishment implemented by a BS in accordance with an embodiment of the present disclosure. The method 500 may be considered as a specific implementation of block 210 of the method 200 described above with reference to FIG. 2. However, it is noted that this is only for the purpose of illustrating the principles of the present disclosure, rather than limiting the scope thereof.

The method 500 is entered in block 510, where the first terminal device and the second terminal device are identified from the data packet. In the embodiments illustrated with respect to FIG. 5, whether the second terminal device is in proximity to the first terminal device and whether the data packet is to be transmitted from the first terminal device to the second terminal device in a shortcut way are both determined at the first BS 110. In other words, neither the P-GW 150 nor the MME 130 are involved in the shortcut transmission in the embodiments.

In some embodiments, in block 510, the first BS 110 may identify or detect the IP addresses of the source (the first terminal device) and the destination (the second terminal device) from the to-be-transmitted data packet, and broadcast any of them to neighboring BS for information sharing. The broadcasting may be implemented by using a new/modified X2 signaling, along with the S1-TEID for each specific IP address.

In block 520, whether the second terminal device is in proximity to the first terminal device is determined. In some embodiments, the first BS 110 may collect serving information about terminal devices served by neighboring base stations of the first base station. Then, the first BS 110 may determine whether the second terminal device is served by one of the neighboring base stations based on the serving information. In response to determining that the second terminal device is served by one of the neighboring base stations, the first BS 110 may determine that the second terminal device is in proximity to the first terminal device.

In some embodiments, based on information about the IP address, either from local inspection at the first BS 110, or from information broadcasted from neighbor(s) of the first BS 110, the first BS 110 may build a mapping table of destination IP address and S1-TEID address. By checking the table, first BS 110 may determine whether the destination IP address (that is, the IP address of the second terminal device) is within the proximity of the first terminal device served by the first BS 110, for example, by determining whether the second terminal device is served by the first BS or by a neighbor of the first BS.

In block 530, in response to determining that the second terminal device is in proximity to the first terminal device, the data packet is determined to be transmitted to the second terminal device in a shortcut way. In block 540, the second base station and the target bearer are determined. In some embodiments, the first BS may determine the neighboring BS 120 as the second base station, and select the target bearer from bearers available to the second base station.

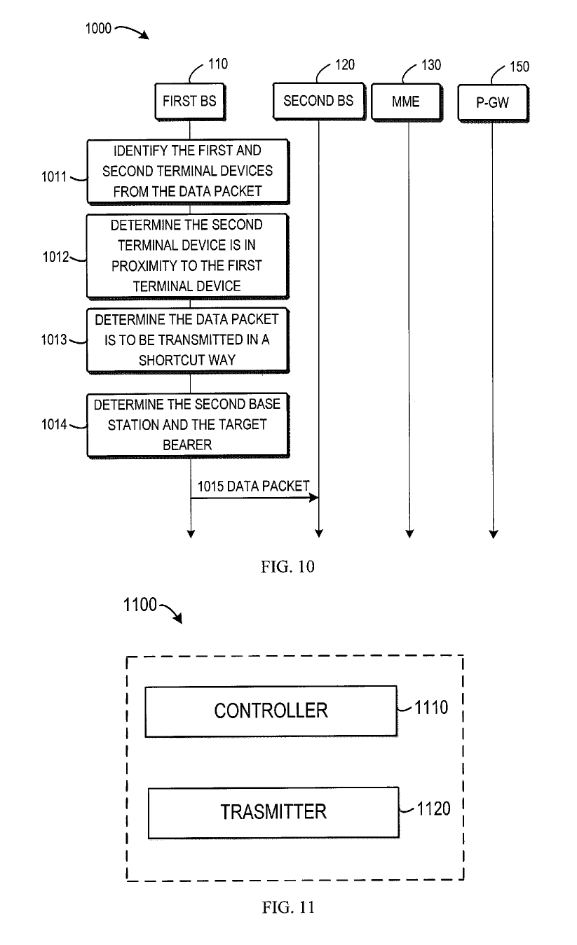

More details of the embodiments of FIG. 5 may be found in FIG. 10, which shows a diagram 1000 of a flow of bearer establishment in accordance with an embodiment of the present disclosure. The example of FIG. 10 illustrates the first BS 110, the second BS 120, the MME 130 and the P-GW 140 of FIG. 1, and the proximity determination is made at the P-GW side. When the flow shown in FIG. 10 starts, the first BS 110 identifies 1011 the first terminal device, for example, the UE 111, and the second terminal device, for example, the UE 121 from the data packet. In the example, it is also assumed that the second BS is a neighbor of the first BS, and thus the first BS 110 may determine 1012 that the UE 121 is in proximity to the UE 111. In response, the first BS 110 determines 1013 that the data packet is to be transmitted in a shortcut way, instead of transmitting to the core network. Then, the first BS 110 may determine 1014 the second BS 120 and the target bearer and transmit 1015 the data packet to the second BS 120 directly. In this way, the data packet can be transmitted from the second BS 120 to the second terminal device (the UE 121) via the target bearer. Thus the core network transportation can be bypassed and related latencies can be reduced.

Now reference is made to FIG. 6, which shows a flowchart of a method 600 for bearer establishment implemented by a network node in accordance with an embodiment of the present disclosure. With the method 600, the above and other potential deficiencies in the conventional approaches can be overcome. It would be appreciated by those skilled in the art that the method 600 may be implemented by a gateway, such as the P-GW 150 or other suitable devices.

The method 600 is entered in block 610, where a data packet is received from a first base station. The source of the data packet is a first terminal device (for example, the UE 111) served by the first base station (for example, the BS 110), and the destination of the data packet is a second terminal device (for example, the UE 121). In block 620, the first terminal device and the second terminal device are identified from the data packet. In block 630, it is determined whether the second terminal device is in proximity to the first terminal device. In block 640, in response to the second terminal device being in proximity to the first terminal device, proximity information indicating that the second terminal device is in proximity to the first terminal device is transmitted to a mobility management entity (for example, the MME 130).

In some embodiments, the MME 130 may determine shortcut information based on the proximity information. The shortcut information may indicate a second base station serving the second terminal device and a target bearer for carrying the data packet from the second base station to the second terminal device.

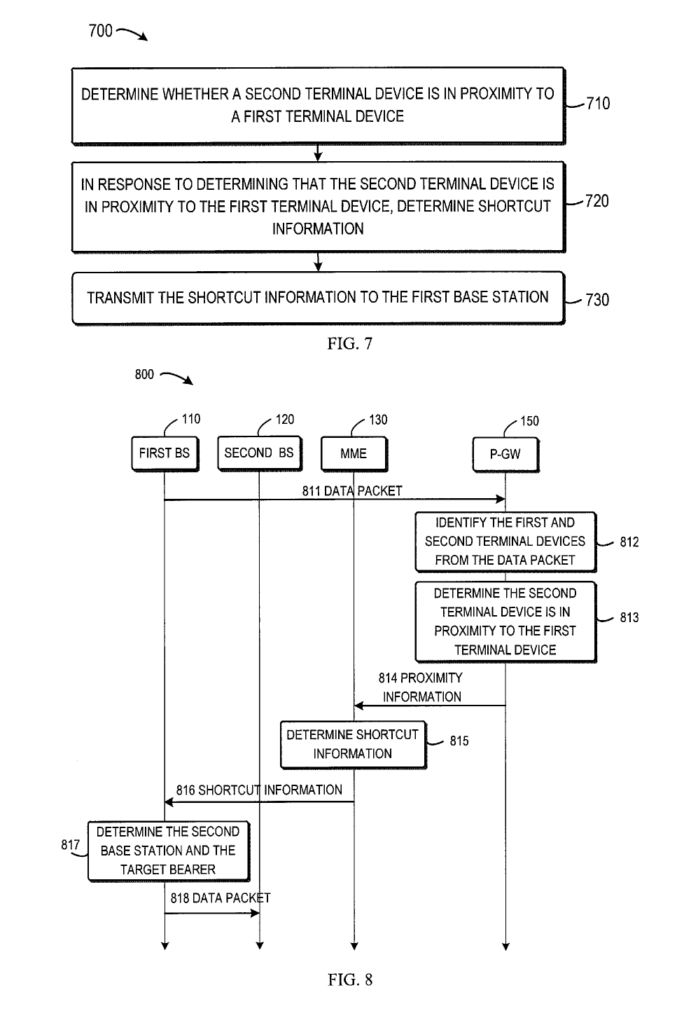

Now reference is made to FIG. 7, which shows a flowchart of a method 700 for bearer establishment implemented by a mobility management entity in accordance with an embodiment of the present disclosure. With the method 700, the above and other potential deficiencies in the conventional approaches can be overcome. It would be appreciated by those skilled in the art that the method 700 may be implemented by a mobility management entity, such as the MME 130 or other suitable devices.

The method 700 is entered in block 710, where whether a second terminal device is in proximity to a first base station is determined. The first base station (for example, the BS 110) serves a first terminal device (for example, the UE 111), and the first terminal device transmitting a data packet to the second terminal device (for example, the UE 121). In some embodiments, the determination may be made by the MME 130 based on information of the first and second terminal devices received from the first BS 110. Then, the MME 130 may determine the second base station based on the received information. If the second base station is a neighbor base station of the first base station, the MME 130 may determine that the second terminal device is in proximity to the first terminal device.

As an alternative, in some embodiments, in response to receiving proximity information from a network node (for example, the P-GW 150), the MME 130 may determine that the second terminal device is in proximity to the first terminal device. The proximity information may be determined at the P-GW 150 in response to the second terminal device being in proximity to the first terminal device.

In block 720, in response to determining that the second terminal device is in proximity to a first base station, shortcut information is determined. The shortcut information indicates a second base station serving the second terminal device and a target bearer for carrying the data packet from the second base station to the second terminal device. In block 730, the shortcut information is transmitted from the MME 130 to the first base station, to cause the data packet to be transmitted from the second base station (for example, the BS 120) to the second terminal device on the target bearer.

FIG. 11 shows a block diagram of a BS 1100 in accordance with an embodiment of the present disclosure. It would be appreciated that the BS may be implemented by the BS 110 as shown in FIG. 1 or other suitable devices.

As shown, the BS 1100 includes a controller 1110 and a transceiver 1120. The controller 1110 is configured to a controller configured to in response to that a data packet is to be transmitted from a first terminal device served by the first base station to the second terminal device in a shortcut way, determine a second base station serving the second terminal device and a target bearer for carrying the data packet from the second base station to the second terminal device. The transmitter 1120 is configured to cause the data packet to be transmitted from the second base station to the second terminal device on the target bearer.

In an embodiment, the controller 1110 may be further configured to: in response to receiving, from a mobility management entity, shortcut information indicating the second base station and the target bearer, determine that the data packet is to be transmitted to the second terminal device in a shortcut way.

In an embodiment, the transmitter 1120 may be further configured to: transmit the data packet to a network node, to enable the network node to identify the first terminal device and the second terminal device from the data packet, determine whether the second terminal device is in proximity to the first terminal device, and transmit proximity information to the mobility management entity if the second terminal device is in proximity to the first terminal device to trigger the mobility management entity to determine the shortcut information based on the proximity information.

In an embodiment, the controller 1110 may be further configured to: identify the first terminal device and the second terminal device from the data packet. In the embodiment, the transmitter 1120 may be further configured to: transmit information about the first terminal device and the second terminal device to the mobility management entity, to enable the mobility management entity to determine whether the second terminal device is in proximity to the first terminal device and determine the shortcut information if the second terminal device is in proximity to the first terminal device.

In an embodiment, the controller 1110 may be further configured to: determine the second base station and the target bearer from the shortcut information.

In an embodiment, the controller 1110 may be further configured to: identify the first terminal device and the second terminal device from the data packet; determine whether the second terminal device is in proximity to the first terminal device; and in response to determining that the second terminal device is in proximity to the first terminal device, determine that the data packet is to be transmitted to the second terminal device in a shortcut way.

In an embodiment, the controller 1110 may be further configured to: collect serving information about terminal devices served by neighboring base stations of the first base station; determine whether the second terminal device is served by one of the neighboring base stations based on the serving information; and in response to determining that the second terminal device is served by one of the neighboring base stations, determine that the second terminal device is in proximity to the first terminal device.

In an embodiment, the controller 1110 may be further configured to: determine the one of the neighboring base stations as the second base station; and select the target bearer from bearers available to the second base station.

In an embodiment, the first base station is different from the second base station. In the embodiment, the transmitter 1120 may be further configured to: transmit the data packet to the second base station, to enable the second base station to transmit the data packet to the second terminal device on the target bearer.

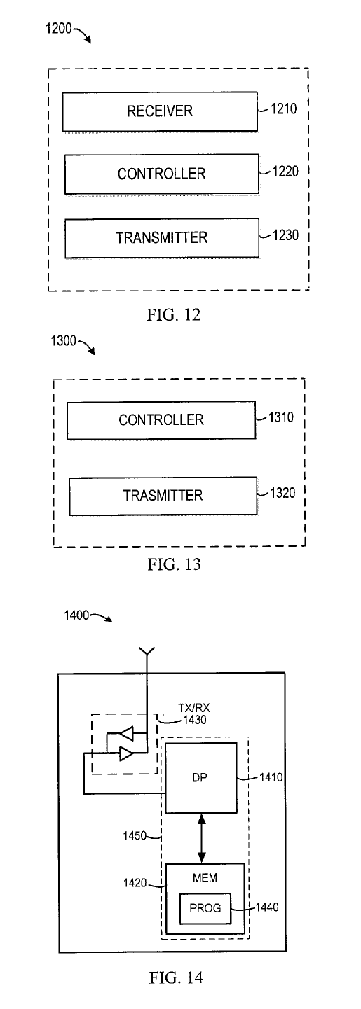

FIG. 12 shows a block diagram of a network node 1200 in accordance with an embodiment of the present disclosure. It would be appreciated that the network node may be implemented by a gateway, such as the P-GW 150 as shown in FIG. 1 or other suitable devices.

As shown, the network node 1200 includes a receiver 1210, a controller 1220 and a transmitter 1230. The receiver 1210 may be configured to receive a data packet from a first base station, a source of the data packet being a first terminal device served by the first base station, and a destination of the data packet being a second terminal device. The controller 1220 may be configured to: identify the first terminal device and the second terminal device from the data packet, and determine whether the second terminal device is in proximity to the first terminal device. The transmitter 1230 may be configured to, in response to the second terminal device being in proximity to the first terminal device, transmit, to a mobility management entity, proximity information indicating that the second terminal device is in proximity to the first terminal device.

In an embodiment, the mobility management entity may determine shortcut information based on the proximity information, the shortcut information indicating a second base station serving the second terminal device and a target bearer for carrying the data packet from the second base station to the second terminal device.

FIG. 13 shows a block diagram of a mobility management entity 1300 in accordance with an embodiment of the present disclosure. It would be appreciated that the mobility management entity 1300 may be implemented by the MME 130 as shown in FIG. 1 or other suitable devices.

As shown, the mobility management entity 1300 includes a controller 1310 and a transmitter 1320. The controller 1310 is configured to: determine whether a second terminal device is in proximity to a first base station, the first base station serving a first terminal device, and the first terminal device transmitting a data packet to the second terminal device, and in response to determining that the second terminal device is in proximity to a first base station, determine shortcut information indicating a second base station serving the second terminal device and a target bearer for carrying the data packet from the second base station to the second terminal device. The transmitter 1320 is configured to transmit the shortcut information to the first base station, to cause the data packet to be transmitted from the second base station to the second terminal device on the target bearer.

In an embodiment, the controller 1310 may be further configured to: in response to receiving proximity information from a network node, determine that the second terminal device is in proximity to the first terminal device, the proximity information being determined at the network node in response to the second terminal device being in proximity to the first terminal device.

In an embodiment, the mobility management entity 1300 may further include: a receiver configured to receiving information about the first terminal device and the second terminal device from the first base station. The controller 1310 may be further configured to: determine the second base station based on the received information, and if the second base station is a neighbor base station of the first base station, determine that the second terminal device is in proximity to the first terminal device.

It should be appreciated that components included in the BS 1100 correspond to the blocks of the methods 200-500, components included in the network node 1200 correspond to the blocks of the method 600, and components included in the mobility management entity 1300 correspond to the blocks of the method 700. Therefore, all operations and features described above with reference to FIGS. 2 to 5 are likewise applicable to the components included in the BS 1100 and have similar effects, all operations and features described above with reference to FIG. 6 are likewise applicable to the components included in the network node 1200 and have similar effects, and all operations and features described above with reference to FIG. 7 are likewise applicable to the components included in the mobility management entity 1300 and have similar effects. For the purpose of simplification, the details will be omitted.

The components included in the devices 1100, 1200 and 1300 may be implemented in various manners, including software, hardware, firmware, or any combination thereof In one embodiment, one or more units may be implemented using software and/or firmware, for example, machine-executable instructions stored on the storage medium. In addition to or instead of machine-executable instructions, parts or all of the components included in the device 1100, 1200 and 1300 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

FIG. 14 shows a simplified block diagram of a device 1400 that is suitable for use in implementing embodiments of the present disclosure. It would be appreciated that the device 1400 may be implemented by a device, such as, the BS 110, the gateway 150 or a MME 130.

As shown, the device 1400 includes a data processor (DP) 1410, a memory (MEM) 1420 coupled to the DP 1410, a suitable RF transmitter TX and receiver RX 1440 coupled to the DP 1410, and a communication interface 1450 coupled to the DP 1410. The MEM 1420 stores a program (PROG) 1430. The TX/RX 1440 is for bidirectional wireless communications. Note that the TX/RX 1440 has at least one antenna to facilitate communication, though in practice an Access Node mentioned in this application may have several ones. The communication interface 1450 may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The PROG 1430 is assumed to include program instructions that, when executed by the associated DP 1410, enable the device 1400 to operate in accordance with the embodiments of the present disclosure, as discussed herein with the methods 200 to 700 in FIGS. 2 to 7. The embodiments herein may be implemented by computer software executable by the DP 1410 of the device 1400, or by hardware, or by a combination of software and hardware. A combination of the data processor 1410 and MEM 1420 may form processing means 1460 adapted to implement various embodiments of the present disclosure.

The MEM 1420 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the device 1400, there may be several physically distinct memory modules in the device 1400. The DP 1410 may be of any type suitable to the local technical environment, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

By way of example, embodiments of the present disclosure can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this disclosure, the device may be implemented in the general context of computer system-executable instructions, such as program modules, being executed by a computer system. Generally, program modules may include routines, programs, objects, components, logic, data structures, and so on that perform particular tasks or implement particular abstract data types. The device may be practiced in distributed cloud computing environments where tasks are performed by remote processing devices that are linked through a communications network. In a distributed cloud computing environment, program modules may be located in both local and remote computer system storage media including memory storage devices.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method implemented at a first base station in a wireless communication network, comprising:
in response to that a data packet is to be transmitted from a first terminal device served by the first base station to the second terminal device in a shortcut way, determining a second base station serving the second terminal device and a target bearer for carrying the data packet from the second base station to the second terminal device; and
causing the data packet to be transmitted from the second base station to the second terminal device on the target bearer.

2. The method according to claim 1, further comprising:
in response to receiving, from a mobility management entity, shortcut information indicating the second base station and the target bearer, determining that the data packet is to be transmitted to the second terminal device in a shortcut way.

3. The method according to claim 2, further comprising:
transmitting the data packet to a network node, to enable the network node to identify the first terminal device and the second terminal device from the data packet, determine whether the second terminal device is in proximity to the first terminal device, and transmit proximity information to the mobility management entity if the second terminal device is in proximity to the first terminal device to trigger the mobility management entity to determine the shortcut information based on the proximity information.

4. The method according to claim 2, further comprising:
identifying the first terminal device and the second terminal device from the data packet; and
transmitting information about the first terminal device and the second terminal device to the mobility management entity, to enable the mobility management entity to determine whether the second terminal device is in proximity to the first terminal device and determine the shortcut information if the second terminal device is in proximity to the first terminal device.

5. The method according to claim 2, wherein determining the second base station and the target bearer comprises:
determining the second base station and the target bearer from the shortcut information.

6. The method according to claim 1, further comprising:
identifying the first terminal device and the second terminal device from the data packet;
determining whether the second terminal device is in proximity to the first terminal device; and
in response to determining that the second terminal device is in proximity to the first terminal device, determining that the data packet is to be transmitted to the second terminal device in a shortcut way.

7. The method according to claim 6, wherein determining whether the second terminal device is in proximity to the first terminal device comprises:
collecting serving information about terminal devices served by neighboring base stations of the first base station;
determining whether the second terminal device is served by one of the neighboring base stations based on the serving information; and
in response to determining that the second terminal device is served by one of the neighboring base stations, determining that the second terminal device is in proximity to the first terminal device.

8. The method according to claim 7, wherein determining the second base station and the target bearer comprises:
determining the one of the neighboring base stations as the second base station; and
selecting the target bearer from bearers available to the second base station.

9. The method according to claim 1, wherein the first base station is different from the second base station, and wherein causing the data packet to be transmitted from the second base station to the second terminal device on the target bearer comprises:
transmitting the data packet to the second base station, to enable the second base station to transmit the data packet to the second terminal device on the target bearer.

10. (canceled)

11. (canceled)

12. A method implemented at a mobility management entity in a wireless communication network, comprising:
determining whether a second terminal device is in proximity to a first base station, the first base station serving a first terminal device, and the first terminal device transmitting a data packet to the second terminal device;
in response to determining that the second terminal device is in proximity to a first base station, determining shortcut information indicating a second base station serving the second terminal device and a target bearer for carrying the data packet from the second base station to the second terminal device; and
transmitting the shortcut information to the first base station, to cause the data packet to be transmitted from the second base station to the second terminal device on the target bearer.

13. The method according to claim 12, wherein determining whether the second terminal device is in proximity to the first terminal device comprises:
in response to receiving proximity information from a network node, determining that the second terminal device is in proximity to the first terminal device, the proximity information being determined at the network node in response to the second terminal device being in proximity to the first terminal device.

14. The method according to claim 12, wherein determining whether the second terminal device is in proximity to the first terminal device comprises:
receiving information about the first terminal device and the second terminal device from the first base station;
determining the second base station based on the received information; and
if the second base station is a neighbor base station of the first base station, determining that the second terminal device is in proximity to the first terminal device.

15-28. (canceled)

29. A device, comprising:
a processor and a memory, the memory containing program including instructions executable by the processor, the processor being configured to cause the device to:
in response to a data packet to be transmitted from a first terminal device served by the first base station to the second terminal device in a shortcut way, determine a second base station serving the second terminal device and a target bearer for carrying the data packet from the second base station to the second terminal device; and
cause the data packet to be transmitted from the second base station to the second terminal device on the target bearer.

30-34. (canceled)

35. The device according to claim 29, wherein the processor is configured to cause the device to:
in response to receiving, from a mobility management entity, shortcut information indicating the second base station and the target bearer, determine that the data packet is to be transmitted to the second terminal device in a shortcut way.

36. The device according to claim 35, wherein the processor is configured to cause the device to:
transmit the data packet to a network node, to enable the network node to identify the first terminal device and the second terminal device from the data packet,
determine whether the second terminal device is in proximity to the first terminal device, and
transmit proximity information to the mobility management entity if the second terminal device is in proximity to the first terminal device to trigger the mobility management entity to determine the shortcut information based on the proximity information.

37. The device according to claim 35, wherein the processor is configured to cause the device to:
identify the first terminal device and the second terminal device from the data packet; and
transmit information about the first terminal device and the second terminal device to the mobility management entity, to enable the mobility management entity to determine whether the second terminal device is in proximity to the first terminal device and determine the shortcut information if the second terminal device is in proximity to the first terminal device.

38. The device according to claim 35, wherein to determine the second base station and the target bearer, the processor is configured to:
determine the second base station and the target bearer from the shortcut information.

39. The device according to claim 29, wherein the processor is configured to cause the device to:
identify the first terminal device and the second terminal device from the data packet;
determine whether the second terminal device is in proximity to the first terminal device; and
in response to determining that the second terminal device is in proximity to the first terminal device, determine that the data packet is to be transmitted to the second terminal device in a shortcut way.

40. The device according to claim 29, wherein to determine whether the second terminal device is in proximity to the first terminal device, the processor is configured to:
collect serving information about terminal devices served by neighboring base stations of the first base station;
determine whether the second terminal device is served by one of the neighboring base stations based on the serving information; and
in response to determining that the second terminal device is served by one of the neighboring base stations, determine that the second terminal device is in proximity to the first terminal device.

41. The device according to claim 40, wherein to determine the second base station and the target bearer, the processor is configured to:
determine the one of the neighboring base stations as the second base station; and
select the target bearer from bearers available to the second base station.

42. The device according to claim 29, wherein the first base station is different from the second base station and to cause the data packet to be transmitted from the second base station to the second terminal device on the target bearer, the processor is configured to:
transmit the data packet to the second base station, to enable the second base station to transmit the data packet to the second terminal device on the target bearer.
